(19) United States
(12) Patent Application Publication
(10) Pub. No.: US 2006/0063453 A1
(43) Pub. Date: Mar. 23, 2006

(54) Multi-color denier gradient fabric

(76) Inventor: Christopher John King, Boulder, CO (US)

Correspondence Address: HOLLAND & HART, LLP, P.O BOX 8749, DENVER, CO, 80201, US

(21) Appl. No.: 10/948,888

(22) Filed: Sep. 23, 2004

(51) Int. Cl. D03D 15/08; D04B 21/14; B32B 5/26; D04H 13/00

(52) U.S. Cl. 442/318; 442/306; 442/327; 442/328; 442/182

(57) ABSTRACT

The present invention provides a multi-color denier gradient fabric. The fabric is constructed such that when stretched, the fabric is not see through.

### FIELD OF THE INVENTION

The present invention relates to fabric and, more particularly, to multi-color denier gradient fabric.

### BACKGROUND OF THE INVENTION

Denier gradient fabric is generally known in the art. In particular, denier gradient fabrics comprise multiple fabric layers having different deniers. The denier gradient causes moisture to travel by capillary action from the larger denier fabric side to a smaller denier fabric side. U.S. Pat. No. 4,733,546, issued Mar. 29, 1988, to Toda, titled “KNITTED FABRIC FOR CLOTHING,” incorporated herein by reference, describes one such variable denier gradient fabric (“Toda”). In particular, Toda describes a fabric having a surface layer yarn of a certain denier, such as, for example, 1.0 denier to 2.5 denier. The back layer of the fabric would be preferably 50% or more larger than the surface layer denier. The voids between the larger denier fibers of the back layer would be larger than the voids between the smaller denier fibers in the surface layer. Thus, capillary action would cause moisture to move from the back layer towards the surface layer. This action has been found useful in designing moisture management fabrics.

One difficulty with denier gradient fabric is that it is difficult without close inspection of the fabric to determine which side of the fabric has the larger denier fibers, and hence larger voids. If the fabric is not aligned properly, the garments made using the fabric may not exhibit the desired moisture management properties. In order to avoid misalignment of the fabric, many denier gradient fabrics include multiple colors. In other words, the larger denier side would be a first color or pattern, such as, for example, a red color, and the smaller denier side would be a second color or pattern, such as, for example, a blue color. The alignment of the fabric to make (and possible wear) the associated garment would be facilitated because the red color would be associated with the back side and the blue color would be associated with the surface side, or more generically, the red to blue colors would be aligned in the desired direction of moisture flow.

The above-described fabric is made using techniques that produce fabrics that are useful for tops and other like garments. However, the garments typically are non-stretchable and/or if stretched produce gaps through which undergarments or skin may be visible. Thus, it would be desirable to develop a cycling short multi-color denier gradient as well as multi-color denier gradient fabric that when stretched does not produce gaps through which undergarments or skin may be visible.

### SUMMARY OF THE INVENTION

To attain the advantages and in accordance with the present invention, a multi-color denier gradient fabric is provided. The fabric comprises a first layer constructed out of a yarn of a first denier and a second layer constructed out of a yarn of a second denier. The plurality of yarns are stitched using a compression stitch and of a sufficient weight to inhibit the ability to see through the fabric when stretched.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 is a cross sectional view of a fabric consistent with an embodiment of the present invention;

FIG. 2 is a plan view of a compression stitch useful in constructing the fabric of FIG. 1;

FIG. 3 is a plan view of an embodiment consistent with an embodiment of the present invention;

FIG. 4 is a perspective view of stretchable athletic pants consistent with an embodiment of the present invention; and

FIG. 5 is a perspective view of stretchable athletic pants consistent with an embodiment of the present invention.

### DETAILED DESCRIPTION

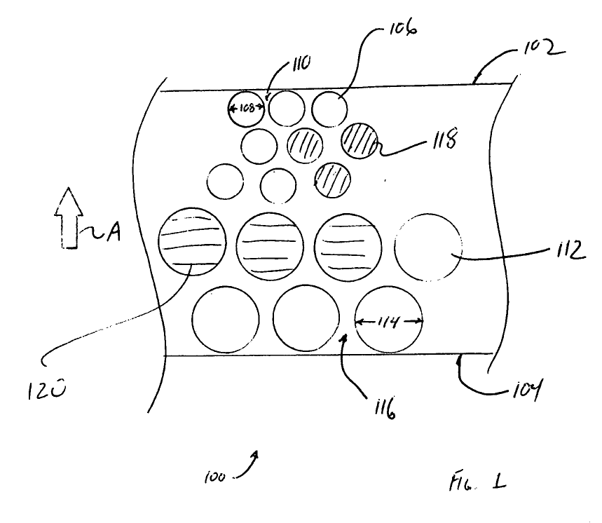

The present invention will be described with respect to FIGS. 1-5. While the present invention will be described with respect to cycling shorts, and warp knits or other compression knits, the examples should be considered exemplary and non-limiting. Further, one of ordinary skill in the art on reading the disclosure that cycling shorts are a particular type of stretchable athletic pants, and references to cycling shorts are exemplary and non-limiting.

Referring first to FIG. 1, a cross-sectional view of a fabric layer 100 is shown. Fabric layer 100 includes a first side 102 and a second side 104. First side 102 comprises a plurality of first fibers 106 having a first denier 108. A plurality of first voids 110 exist between the plurality of first fibers 106. Second side 104 comprises a plurality of second fibers 112 having a second denier 114. A plurality of second voids 116 exist between the plurality of second fibers 112. As shown, first denier 108 is less than second denier 112. Directional arrow A shows that moisture would flow from second side 104 towards first side 102 by capillary action. Generally, moisture management garments direct moisture away from the body. Thus, first side 102 would be an external surface of the garment, and second side 104 would be an internal surface of the garment.

As mentioned above, fabric layer 100 may be multi-colored or multi-patterned to assist in fabric alignment. For example, fibers 106 may be a color or pattern 118 indicative that fibers 106 are associated with first side 102. Fibers 112 may be a color or pattern 120 indicative that fibers 112 are associated with second side 104. Patterning and coloring fibers 106 and 112 can be accomplished using most known methods but coloring the fabric is the more conventional style. Any type of coloring process could be used, such as cross dying, batch dying, and yarn dying methods, but it has been found that yarn dying works well.

As mentioned above, the denier gradient fabrics conventionally are see-through when stretched. Thus, the present invention uses a heavier grade or weight fabric. The heavier grade inhibits the see-through effect when the fabric is stretched. Generally, a fabric weight of 120 grams per square meter is sufficient to inhibit the see-through effect, but other weights are possible depending on the stitch, material, stretch, etc.

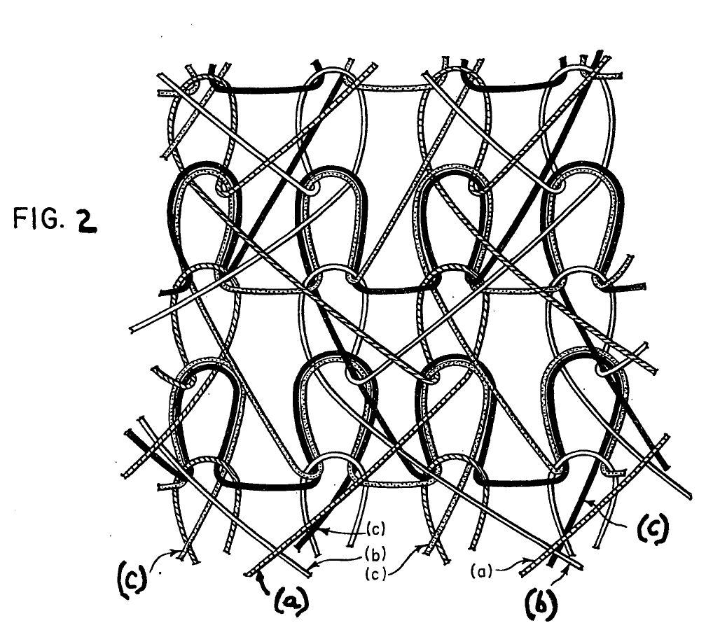

Referring now to FIG. 2, a fabric 200 using a warp knit is shown. Denier gradient fabrics may be constructed from a single machine interweaving various yarns, but it is also possible to construct distinct layers of fabric having different deniers and bond those fabrics together. The bonding could be a stitch, adhesive, or other conventional bonding techniques. Referring specifically to the fabric 200 shown in FIG. 2, fabric 200 shows a warp knitted elastic fabric comprising a lattice a and a lattice b of knitted non-elastic threads held together by a web c of knitted elastic threads. Fabric 200 could of course have several constructions that are conventional in the art, but the warp knit allows for stretch in fabric 200 while assisting in inhibiting the see through effect of most stretched fabric. For more information on warp knits, see U.S. Pat. No. 3,931,721, issued Jan. 13, 1976, to Adamson, titled WARP KNITTED ELASTIC FABRIC and U.S. Pat. No. 6,370,924, issued Apr. 16, 2002, to Takeuchi, titled WARP-KNITTED FABRIC FOR INFLATABLE BELT COVER, both of which are incorporated herein by reference. While a conventional warp knit is shown and described, it is possible to use any compression stitch. Other conventional knits as known in the art would also function in the present invention, such as, circular and woven knits. Also, while fabric 200 is described as a knit, one of ordinary skill in the art would understand on reading the disclosure that other types of fabrics could be constructed using other woven or non-woven techniques.

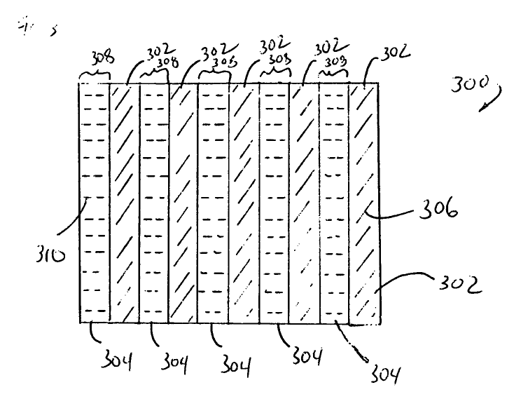

Referring now to FIG. 3, a top plan view of a portion of a stretched, multi-color denier gradient fabric 300 is shown. Fabric 300 has a surface layer 302 and a backside layer 304. In this example, surface layer 302 has a first color 306 represented by “//.” When stretched, as shown, surface layer 302 provides gaps 308 through which backside layer 304 can be seen, backside layer 304 has a second color 310 represented by “- -.” Thus, when stretched, fabric 300 has a marbled or ribbed appearance because second color 310 of backside layer 304 can be seen through gaps 308 of surface layer 302.

Instead of a marbled layer, it is possible to provide a blended color to fabric 300 by the arrangement and types of fibers and stitch. For example, if first color 306 was a blue color and second color 310 was a yellow color, then when the fabric is stretched, fabric 300 may take on a green hue.

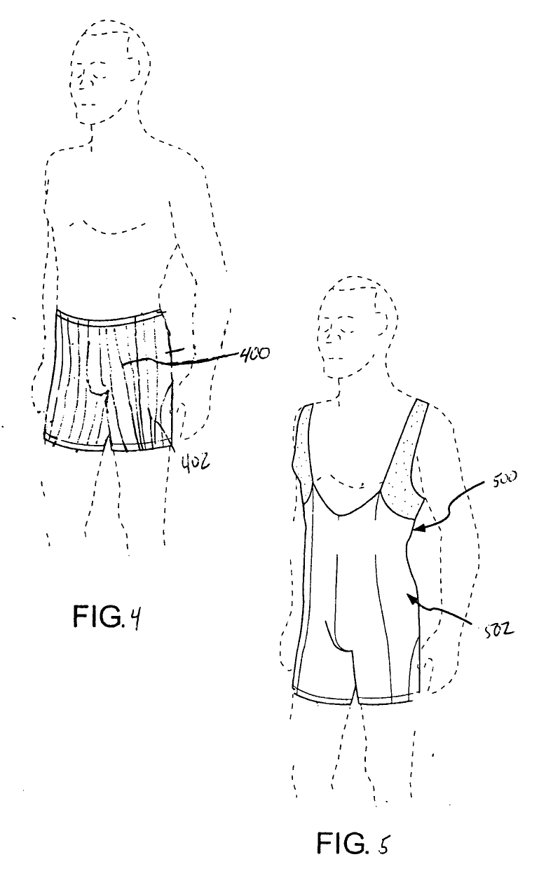

Referring now to FIGS. 4 and 5, cycling shorts 400 and 500 can be seen. Cycling shorts 400 made out of fabric 300 having fibers sized and arranged to result in the marbled or ribbed feature 402. Cycling shorts 500 made out of fabric 300 having fibers sized and arranged, and stitched (individually or a combination thereof) to result in a blended hue that combines the colors of the surface and backsides. Also, because use of the compression stitch, as described above, inhibits seeing through cycling shorts 400 and 500. While shown as cycling shorts, one of skill in the art would now, on reading the disclosure, know that other stretchable athletic pants could be made, including other shorts or long pants.

To make, for example, cycling shorts using a warp knit consistent with the present invention, first you obtain a yarn of a first denier, a yarn of a second denier, and a third yarn of a third denier. One of the yarns should be elastic for the warp knit construction. The deniers of the yarn should be chosen to provide the desired moisture management properties. The yarns may than be knitted, using for example, a warp knit machine, into a greige. The griege is then made into a finished fabric by, for example, refining and heating the greige. One methodology to dye the fabric includes a yarn dye method, but other methods could be used as desired. For the yarn dye method, assume a first nylon yarn and a second cation dye polyester for the second yarn. In this case, the nylon yarn is dyed with, for example, acid dyes. The cation dye polyester would be dyed with cation dye stuff. The dyes would then be fixed with resins, soaped and washed. Wicking agents could be applied to provide moisture management as desired. The fabric is finished by a final heating. As one of ordinary skill in the art would now recognize, other processes could be substituted for the above as are generally known in the art.

While the above describes a particular way to manufacture and color a fabric consistent with the present invention, one of ordinary skill in the art would understand that variations on the above are possible. For example, other compression stitches may be used instead of the warp knit. Further, other woven or non-woven fabrics could be made instead of knit fabrics. Lastly, other dye methods could be used to dye the fabric, such as, for example, batch dying, cross dying, or the like.

While the invention has been particularly shown and described with reference to an embodiment thereof, it will be understood by those skilled in the art that various other changes in the form and details may be made without departing from the spirit and scope of the invention.

We claim:

1. A fabric, comprising:
a first layer comprising a yarn of a first denier;
a second layer coupled to the first layer comprising a yarn of a second denier;
the first denier being less than the second denier such that moisture moves from the second layer towards the first layer;
the plurality of first yarns and second yarns stitched using a compression stitch to form the fabric; and
at least the second layer being constructed with a sufficient weight to inhibit an ability to see through the fabric when the fabric is stretched.

2. The fabric according to claim 1, wherein the weight comprises at least about 120 grams per square meter

3. The fabric according to claim 1, wherein the compression stitch includes a third yarn having elastic properties and the compression stitch comprising a warp knit.

4. The fabric according to claim 1, wherein the fabric comprises a woven or non-woven.

5. The fabric according to claim 1, wherein the fabric is a knit fabric.

6. The fabric according to claim 1, wherein the first layer further comprises a first color and the second layer further comprises a second color.

7. The fabric according to claim 6, wherein the fabric has a marbled look when stretched.

8. The fabric according to claim 6, wherein the fabric takes on a hue of a third color when stretched.

9. The fabric according to claim 8, wherein the third color is a blend of the first color and the second color.

10. The fabric according to claim 1 formed into a cycling short.

11. A pair of stretchable athletic pants, comprising:
a denier gradient fabric; the denier gradient fabric, comprising:
a first layer of fabric comprising a plurality of fibers of a first denier;
a second layer of fabric couple to the first layer of fabric comprising a plurality of fibers of a second denier;
the first layer of fabric having a first color;
the second layer of fabric having a second color; and
means in the stretchable athletic pants to inhibit the ability to see through the pair of stretchable athletic pants.

12. The pair of stretchable athletic pants according to claim 11 wherein the means in the stretchable athletic pants to inhibit the ability to see through the pair of stretchable athletic pants comprises at least the second layer of fabric having a weight of at least about 120 grams per square meter.

13. The pair of stretchable athletic pants according to claim 11, wherein the first color and second color can be seen when the pair of stretchable athletic pants are stretched.

14. The pair of stretchable athletic pants according to claim 11, wherein a third color is visible when the stretchable athletic pants are stretched.

15. The pair of stretchable athletic pants according to claim 11, wherein the means to inhibit the ability to see though the stretchable athletic pants is a heavy fabric weight.

16. The pair of stretchable athletic pants according to claim 15, wherein the means to inhibit the ability to see through the stretchable athletic pants also includes using a compression stitch.

17. The pair of stretchable athletic pants according to claim 11, wherein the denier gradient fabric is a woven or a non-woven.

18. A method of making a multicolor non-see through denier gradient fabric, the method comprising the steps of:
obtaining a first yarn of a first denier;
obtaining a second yarn of a second denier, the second denier different than the first denier, at least the second yarn being of a sufficient weight to inhibit an ability to see through a finished fabric when stretched;
obtaining a third yarn, at least the third yarn being elastic;
using a compression stitch machine to form a greige from the first yarn, the second yarn, and the third yarn;
coloring the first yarn with a first color and the second yarn with a second color, the second color is different than the first color; and
finishing the fabric.

19. The method of making according to claim 18, further comprising using a warp knit machine to form the greige.

20. The method of making according to claim 19, further comprising forming cycling garments from the fabric, wherein the cycling garments are selected from a group of garments consisting of cycling shorts and cycling shirts.

21. The method of making according to claim 19, wherein the coloring step includes coloring the first yarn using a yarn dye method and coloring the second yarn using a yarn dye method.

22. The method of making according to claim 18, further comprising the step of adding a wicking agent to the fabric.
